(19) United States
(12) Patent Application Publication
(10) Pub. No.: US 2013/0004070 A1
(43) Pub. Date: Jan. 3, 2013

(54) Skin Color Detection And Adjustment In An Image

(76) Inventors: Huanzhao Zeng, Vancouver, WA (US); Shilin Guo, San Diego, CA (US); Tuo Wu, San Diego, CA (US)

(21) Appl. No.: 13/171,093

(22) Filed: Jun. 28, 2011

(51) Int. Cl. G06K 9/00

(52) U.S. Cl. 382/167

(57) ABSTRACT

A preferred skin tone region is determined within a luminance-chrominance color space for each of a plurality of luminance values. Additional preferred skin tone regions are determined by interpolation in view of the initially determined preferred skin tone regions. An ellipsoid skin-color model is generated in the luminance-chrominance color space based on the preferred skin tone regions. The ellipsoid skin-color is used to detect a skin color pixel in an image and adjust one or more color values for the skin color pixel.

### BACKGROUND

Digital image quality is influenced by objective and subjective factors. Image resolution is an example of an objective factor affecting image quality. Subjective factors may involve, for example, human perception and/or preference. An observer's preference for skin tone reproduction in an image is a subjective factor that can have significant influence on an observer's perception of image quality.

### BRIEF DESCRIPTION OF DRAWINGS

The following description includes discussion of figures having illustrations given by way of example of implementations of embodiments of the invention. The drawings should be understood by way of example, not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive:

FIG. 1 is a diagram illustrating a color model according to various embodiments.

FIG. 2 is a block diagram illustrating a system according to various embodiments.

FIG. 3 is a flow diagram of operation in a system according to various embodiments.

FIG. 4 is a block diagram illustrating a system according to various embodiments.

### DETAILED DESCRIPTION

Given the human eye's sensitivity to variations and/or abnormalities in the reproduction of skin tones in images, various techniques for improving the reproduction of skin tones in images may be employed to improve image quality (or perception of image quality). Among possible techniques, skin tone preferences may be modeled with ellipses using hue range and/or chroma range. Images, including digital images, are commonly captured using RGB (red, green, blue) color values. In adjusting skin tones to improve image quality, RGB color values may be converted to a luminance-chrominance color space for skin color detection based on an elliptical model. Representative elliptical models may be two-dimensional based on, for example, red-difference chroma and blue-difference chroma components in view of a single (e.g., average) luminance value. In such models, chromaticity values of skin color pixels may be adjusted to reflect preferred skin tones.

Embodiments described herein present methods and systems to adjust skin tone color values to reflect preferred skin tones based on an ellipsoid (three-dimensional) model that incorporates a spectrum of luminance values in addition to two-dimensional chrominance values.

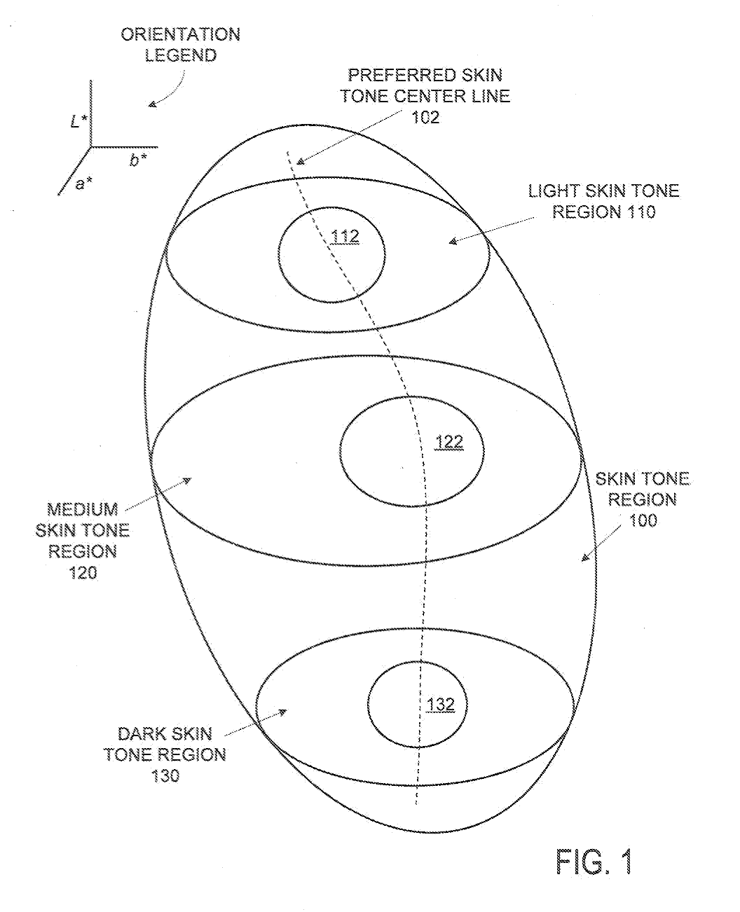

FIG. 1 is a block diagram illustrating a three-dimensional (3-D) color model according to various embodiments. In particular, the model is an ellipsoid representing skin colors within a luminance-chrominance color space. FIG. 1 includes particular components, features, etc. according to various embodiments. However, in different embodiments, more, fewer, and/or other components, features, arrangements, etc. may be used according to the teachings described herein.

The ellipsoid skin color model of FIG. 1 provides for computational efficiency and accuracy in skin color detection, as described herein. The Mahalanobis distance of a point (x, y, z) to the ellipsoid center (x0, y0, z0) is:

Φ(x,y,z)=u₀(x−x₀)²+u₁(x−x₀₎)(y−y₀)+u₂(y−y₀)²+u₃(x−x₀)(z−z₀)+u₄(y−y₀)(z−z₀)+u₅(z−z₀)²,

where coefficients are trained using a large image database. Φ(x, y, z)<ρ defines the boundary of the ellipsoid.

The orientation legend shown in FIG. 1 illustrates the three axes that serve as the basis for the color model. As shown, the color model is based on a uniform Lab color space (e.g., CIELAB), where dimension L represents lightness (e.g., luminance), and a and b represent the color opponent dimensions (e.g., blue-difference chroma and red-difference chroma). Other perceptual uniform color spaces could also be used (e.g., a CIELUV space).

Where a single preferred skin tone region is used to process a color image, the source color of each pixel is converted, for example, to CIELAB. The Mahalanobis distance, Φ(L, a, b), is computed according to the skin tone distribution ellipsoid model Φ(L, a, b). A weight, w, to adjust skin color is computed using the Mahalanobis distance. At the ellipsoid center, Φ(L, a, b)=0, w is maximized; on the ellipsoid boundary, Φ(L, a, b)=ρ, w is minimized. The pseudo code to adjust the chromatic coordinates (a*, b*) is given by (lightness is ignored):

```
if (Φ(L, a, b) < p){
  r = Φ(a, b) / p;
....w = s0 (1−r);
  a_new = a + w*(center_a − a);
  b_new = b + w*(center_b − b);
}
else{
  a and b are not modified;
}
```

In the above equation, (center_a, center_b) is a center point of the preferred skin tone region; s0 is a parameter to adjust the strength of adjustment; and a, b are the (a*,b*) chrominance values of a skin color. Lightness is not adjusted, because it may amplify noise if the original image is noisy.

Building on the example above, to enable color adjustments for multiple lightness levels using multiple preferred skin tone regions (e.g., light skin tone region 110, medium skin tone region 120, and dark skin tone region 130), multiple center points are used as parameters. As illustrated in FIG. 1, the large ellipsoid defines the skin tone region 110. Each of three preferred skin tone center points is at the center of each preferred skin tone region 112, 122, and 132, respectively. Preferred skin tone center line 102 represents preferred skin tone center points interpolated from the center points of preferred skin tone regions 112, 122, and 132. With this property, (center_a, center_b) becomes a function of lightness. Each skin color is morphed toward a corresponding preferred skin tone center 102 with the same lightness.

In various embodiments, the preferred skin tone regions 112, 122, and 132 are determined experimentally by subjecting human observers to a variety of images of people with different skin tones and soliciting their preferences. For example, a variety of images captured using various digital cameras could be presented to one or more groups of people. The images might include people with different skin tones, including people with different geographic and/or ethnic backgrounds. The original images might be modified in chrominance space to produce various skin tones versions. By presenting both the original and processed versions of each image to the observers, preference data may be generated (e.g., capturing the observer's acceptance of the skin tones according to preference and determining the preferred color centers and regions using statistical discriminance analysis, assuming the most acceptable would be likely the most preferred). Other visual experiment methods could be performed to obtain human feedback and other analysis techniques could be used to generate the preference data.

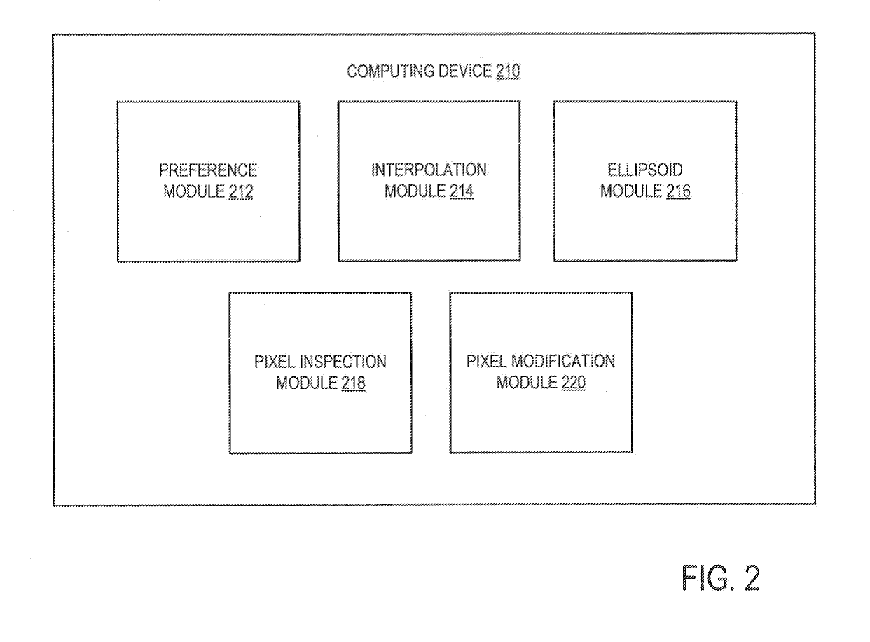

FIG. 2 is a block diagram illustrating a computing device according to various embodiments. FIG. 2 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

Computing device 210 could be any device capable of processing images, including, for example, desktops, notebooks, mobile devices, tablets, photo kiosks, imaging and printing devices, etc. Preference module 212 characterizes a preferred skin tone region within a luminance-chrominance color space (e.g., L*a*b* color space, etc.) for each of plurality of lightness (e.g., luminance) values. In various embodiments, the preference module uses preference data obtained via experimentation, as discussed above. Customized preference data could be used in alternate embodiments.

Interpolation module 214 interpolates additional preferred skin tone regions and/or preferred skin tone center points based on the preferred skin tone regions characterized by preference module 212. Ellipsoid module 216 generates an ellipsoid skin color model in the luminance-chrominance color space based on both the characterized and interpolated preferred skin tone regions.

Pixel inspection module 218 detects skin color pixels in an image. For example, pixel inspection module 218 may define a threshold for determining skin color pixels in view of the ellipsoid skin color model. For pixels detected as skin color pixels, pixel modification module 220 modifies one or more color values for the skin color pixels based on the ellipsoid skin color model.

Various modules and/or components illustrated in FIG. 2 may be implemented as a computer-readable storage medium containing instructions executed by a processor and stored in a memory for performing the operations and functions discussed herein.

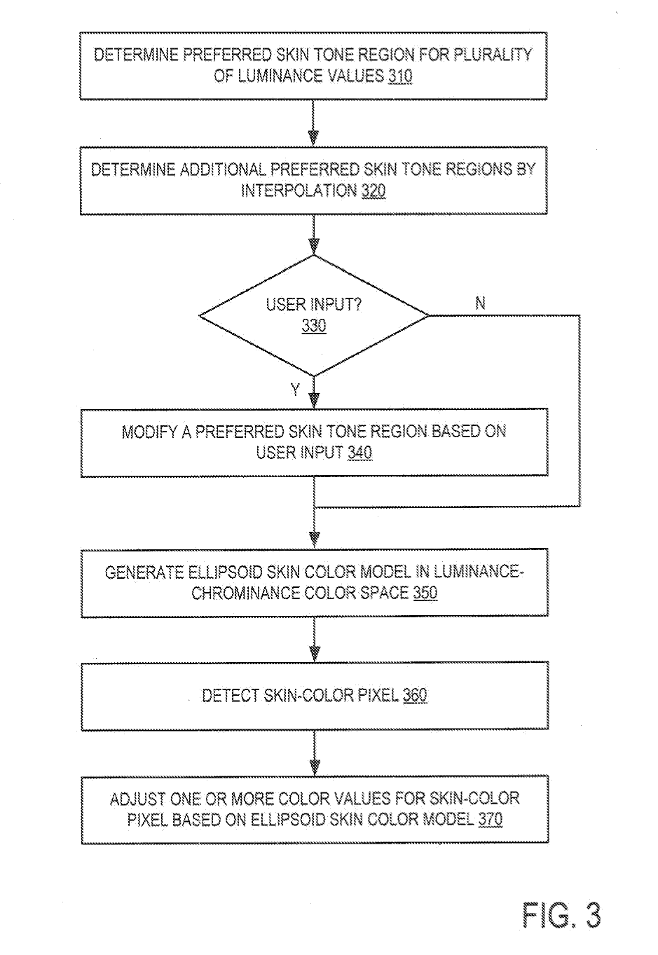

FIG. 3 is a flow diagram of operation in a system according to various embodiments. FIG. 3 includes particular operations and execution order according to certain embodiments. However, in different embodiments, other operations, omitting one or more of the depicted operations, and/or proceeding in other orders of execution may also be used according to teachings described herein.

A preferred skin tone region is determined 310 for a plurality of luminance values within a luminance-chrominance color space. In various embodiments, preferred skin tone regions are determined based on experimentation (e.g., collecting feedback from observers on preferences between modified and unmodified versions of various images). Experimentation results may be provided to a computing system and processed to define and/or refine preferred skin tone regions.

Based on initially determined preferred skin tone regions, a computing system interpolates 320 additional preferred skin tone regions. If user input is received 330, the computing system modifies 340 one or more preferred skin tone regions. For example, a user interface may be provided which allows a user to adjust personal preferences with respect to various image parameters (e.g., hue, saturation, strength). Additionally, a user may be provided with an option to select a geographic region or ethnic background (e.g., where image parameters for each geographic region or ethnic background are customized). The computing system obtains 350 an ellipsoid skin color model in a luminance-chrominance color space (e.g., CIELAB) trained using a large number of images and in view of any user input received.

Based on the ellipsoid skin color model, the computing system detects 360 skin color pixels in an image and adjusts 370 one or more color values for the skin color pixels toward preferred skin tones. In various embodiments, the adjustment of high L* colors is reduced. For example, the adjustment strength, s0, may be multiplied by a factor, w_L, where w_L starts at 1 in the lower lightness range and is gradually reduced to 0 at higher lightness values. In other embodiments, very light skin color may only be subjected to hue adjustments. For example, the hue angle of the preferred skin tone center for light skin tone region (e.g., region 110 of FIG. 1) may be used to adjust light skin colors. A smooth transition for the adjustment in the light skin tone region (e.g., region 110) may be applied. An example of pseudo code for the processing provides:

```
if (Φ(L, a, b) < p){
  r = Φ(a, b) / p;
....w = s0 (1−r);
dA = center_a − a;
dB = center_b − b;
  if (L <= 65){//regular adjustment
    a_new = a + w*dA;
    b_new = b + w*dB;
}
else{//highlight skin colors with L* > 65
  w_L = (100 − L)/(100 − 65);
  if (Preserve Highlight Hue){
    //the portion of regular adjustment
    A = a + w_L*dA;
    B = b + w_L*dB;
    //the portion of adjustment to only adjusting hue and preserving
    chroma
    hue = atan2(A, B);
    chroma = sqrt(a\hat{ }2 + b\hat{ }2);
    A1 = cos(hue) chroma;
    B1 = sin(hue) chroma;
    //blend two adjustments for smooth transition from mid-ton to
    light-tone
    a_new = A (1−w_L) + A1 * w_L;
    b_new = B (1−w_L) + B1* w_L;
  }
  else{//reduced adjustment for highlight
    a_new = a + w_L * w * dA;
    b_new = b + w_L * w * dB;
  }
}
}
else{
  a and b are not modified;
}
```

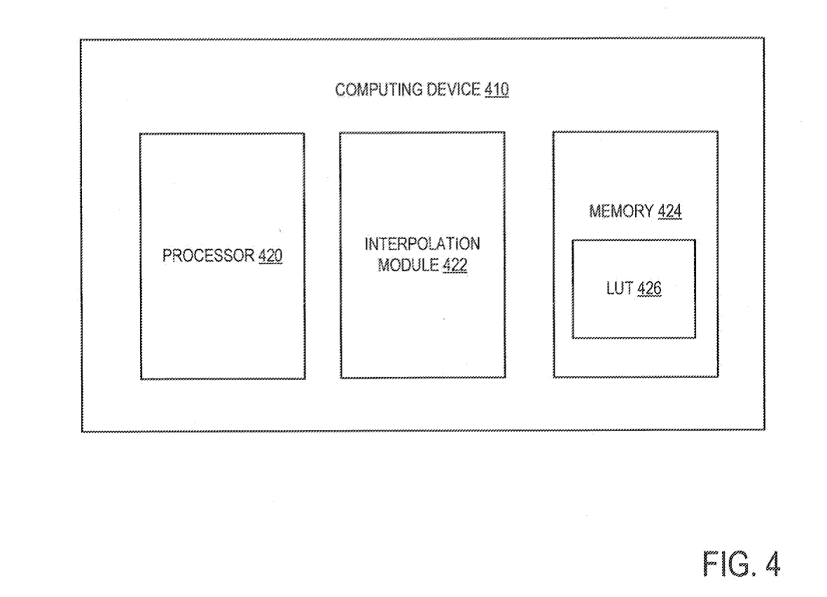

FIG. 4 is a block diagram illustrating a computing device according to various embodiments. FIG. 4 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

Computing device 410 could be any device capable of processing images, including, for example, desktops, notebooks, mobile devices, tablets, imaging kiosks, imaging and printing devices, etc. A lookup table (LUT) 426 is stored in memory 424. In various embodiments, LUT 426 is a reduced-resolution LUT. In various embodiments, LUT 426 is a pre-generated lookup table (e.g., generated by the process described FIG. 3). Interpolation module 422 adjusts color values for pixels in an image using 3-D interpolation that is based on LUT 426.

In some embodiments, multiple LUTS may be stored in memory 424, each LUT specific to a particular ethnic background, and/or geographic region (e.g., Asia, Africa, Europe, etc.), and/or other user input parameters. In such embodiments, each LUT is tailored to the preferences (e.g., tested experimentally) of people specific to each ethnic background or geographic region. When multiple LUTs are available for processing images, a user interface may be provided, allowing a user to select which geographic region or ethnic background is applicable for processing the images.

Various modules and/or components illustrated in FIG. 4 may be implemented as a computer-readable storage medium containing instructions executed by a processor (e.g., processor 424) and stored in a memory (e.g., memory 426) for performing the operations and functions discussed herein.

Various modifications may be made to the disclosed embodiments and implementations of the invention without departing from their scope. Therefore, the illustrations and examples herein should be construed in an illustrative, and not a restrictive sense.

What is claimed is:

1. A method, comprising:
determining a preferred skin tone region within a luminance-chrominance color space for each of a plurality of luminance values;
determining by interpolation additional preferred skin tone regions based on the initially determined preferred skin tone regions;
obtaining an ellipsoid skin color model in the luminance-chrominance color space based on the preferred skin tone regions;
detecting a skin color pixel in an image; and
adjusting one or more color values for the skin color pixel based on the ellipsoid skin color model.

2. The method of claim 1, wherein the adjusting is weighted based at least in part on a distance between the ellipsoid coordinates of the skin color pixel values and the ellipsoid coordinates of the preferred skin tone for the skin color pixel in the luminance-chrominance color space.

3. The method of claim 2, wherein the distance is a three-dimensional Mahalanobis distance.

4. The method of claim 1, wherein the adjusting comprises: transforming input color values from the skin color pixel to output color values via a reduced-resolution lookup table (LUT) based on the ellipsoid skin color model.

5. The method of claim 1, further comprising:
modifying a preferred skin tone region based on user input.

6. The method of claim 5, wherein the user input comprises input on one or more skin tone color parameters including at least:
a hue parameter;
a saturation parameter;
a strength parameter.

7. A computer-readable storage medium containing instructions that, when executed, cause a computer to:
define a preferred skin tone region within a luminance-chrominance color space for each of a plurality of luminance values;
determine by interpolation additional preferred skin tone regions based on the initially determined preferred skin tone regions;
generate an ellipsoid skin color model in the luminance-chrominance color space based on the preferred skin tone regions;
detect a skin color pixel in an image; and
modify one or more color values for the skin color pixel based on the ellipsoid skin color model.

8. The computer-readable storage medium of claim 7, wherein the instructions that cause the modifying comprises further instructions that cause the computer to:
apply a weight to the modifying based at least in part on a distance between the ellipsoid coordinates of the skin color pixel values and the ellipsoid coordinates of the preferred skin tone for the skin color pixel in the luminance-chrominance color space.

9. The computer-readable storage medium of claim 8, wherein the distance is a three-dimensional Mahalanobis distance.

10. The computer-readable storage medium of claim 7, wherein the instructions that cause the modifying comprises further instructions that cause the computer to:
transform input color values from the skin color pixel to output color values via a reduced-resolution lookup table (LUT) based on the ellipsoid skin color model.

11. The computer-readable storage medium of claim 7, comprising further instructions that cause the computer to:
modify a preferred skin tone region based on user input.

12. The computer-readable storage medium of claim 11, wherein the user input comprises input on one or more skin tone color parameters including at least:
a hue parameter;
a saturation parameter;
a strength parameter.

13. A system, comprising:
a memory to store a reduced-resolution lookup table (LUT) based on an ellipsoid skin color model in a luminance-chrominance color space, the ellipsoid skin color model having preferred skin tone regions for different luminance values; and
an interpolation module to adjust color values for pixels in an image via three-dimensional interpolation based at least in part on the LUT.

14. The system of claim 13, further comprising:
a weighting module to apply a weight to the adjustment of color values for pixels based at least in part on a distance between ellipsoid coordinates of skin color pixel values and ellipsoid coordinates of the preferred skin tone for the skin color pixel in the luminance-chrominance color space.

15. The system of claim 14, wherein the distance is a three-dimensional Mahalanobis distance.
